(19) United States
(12) Patent Application Publication
(10) Pub. No.: US 2019/0078384 A1
(43) Pub. Date: Mar. 14, 2019

(54) GUIDE DEVICE FOR GUIDING AN ERECTED SCREEN AND METHOD FOR MOUNTING A GUIDE PROFILE OF SUCH A GUIDE DEVICE ON A DOOR OR FRAME PROFILE

(71) Applicant: RENSON SUNPROTECTION-SCREENS NV, Waregem (BE)

(72) Inventors: Joost Benjamin Renaat DE FRENE, Waregem (BE); John Peter MEINSTER, Gentbrugge (BE)

(21) Appl. No.: 15/772,532

(22) PCT Filed: Oct. 28, 2016
(86) PCT No.: PCT/EP2016/076030

§ 371 Date: Apr. 30, 2018

(30) Foreign Application Priority Data
Oct. 30, 2015 (BE) BE-2015/5710

(51) Int. Cl. E06B 9/58; E06B 7/14

(52) U.S. Cl. CPC E06B 9/581; E06B 2009/543; E06B 9/582; E06B 7/14

(57) ABSTRACT

A guide device (1) for guiding the bottommost side of a screen (4) which can be rolled up and unrolled on an erected screen roller, or a horizontally displaceably erected screen, comprising a guide profile (6, 6′), and holders (9, 9′) for the mounting of the guide profile (6, 6′), such that these holders (9, 9′) are arranged at a distance apart, so that a free space (22) extends between these holders (9, 9′). In addition, an assembly of such a guide device (1) with a door of frame profile (21), a screen device (2) comprising such a guide device (1), an assembly of such a screen device (2) and a door or frame profile (21), and a method for mounting such a guide device (1) on a door or frame profile (21).

The present application claims priority from Belgian Patent Application No. BE-2015/5710 filed on Oct. 30, 2015, which is incorporated herein by reference.

### FIELD OF THE DISCLOSURE

This disclosure relates to a guide device for guiding the bottommost side of a screen which can be rolled up and unrolled on an erected screen roller, or a horizontally displaceably erected screen, during the roll-up and unrolling movement or the sliding movement of this screen, comprising a guide profile.

In addition, this disclosure relates to a guide assembly comprising a door or frame profile having one or more drainage openings, and to such a guide device whereof the guide profile is provided to be mounted against the door or frame profile.

This disclosure further relates to a screen device comprising an erected screen roller, a screen which can be rolled up and unrolled on this screen roller, or comprising a horizontally displaceably erected screen, and to such a guide device and an assembly of such a screen device and a door or frame profile.

Finally, this disclosure also relates to a method for mounting a guide profile of such a guide device against a door or frame profile.

By an erected screen roller is here understood a screen roller which can be erected in any arrangement deviating from a horizontal arrangement. Typically, such a screen roller shall be vertically arranged. However, it is also possible, for example, that this is obliquely arranged, so that this screen device can at least partially shield a window-shaped frame or liberate it.

By an erected screen is understood a screen which can be set up in any arrangement deviating from a horizontal arrangement.

A screen which can be rolled up and unrolled on a screen roller shall, of course, be of flexible construction. A horizontally displaceable screen is typically of rigid construction, but can also be of flexible construction.

More specifically, this disclosure relates to such devices and assemblies which are provided to be arranged in an outdoor environment.

### BACKGROUND

It is then known to provide the guide profile of such devices and assemblies with drainage openings in order to be able to lead precipitation away from this guide profile via these drainage openings, as is described, for example, in US 2003/0079844 A1.

A problem herein is that in an outdoor environment of this type, however, dust and dirt can block such drainage openings and/or can accumulate in the guide profile itself, so that the guidance of the bottommost side of the screen is compromised.

An additional problem herein is that it is often wished to mount such a guide profile against a door or frame profile in which drainage openings are provided. In most cases, this guide profile is not then mounted simultaneously with the said door or frame profile. It is thus wished to be able to install one and the same guide profile for a wide variety of door or frame profiles having different sorts of dimensions and different possible configurations of drainage openings. The guide profile is then preferably placed fully in front of such a door or frame profile in order to have this guide profile influenced as little as possible by the different sorts of dimensions of such door or frame profiles. However, it is then impossible to successfully gear this guide profile to all kinds of possible configurations of drainage openings in such door or frame profiles, so that in most cases the guide profile will block the drainage openings in the door or frame profile in front of which it is placed. Instead, additional openings then need to be made in the guide profile in order to restore the drainage via the drainage openings in the door or frame profile. The making of such additional openings is not just a laborious task, but is also in many cases not readily possible.

### SUMMARY

An object of embodiments of this invention is to remedy the said problems.

This object may be achieved by providing a guide device for guiding the bottommost side of a screen which can be rolled up and unrolled on an erected screen roller, or a horizontally displaceably erected screen, during the roll-up and unrolling movement or the sliding movement of this screen, comprising a guide profile, wherein this guide device comprises a plurality of holders for the guide profile, for the mounting of the guide profile, such that these holders, following assembly, viewed in the longitudinal direction of the guide profile, are arranged at a distance apart, so that a free space extends between these holders and such that each holder extends at least partially alongside and/or at least partially below the guide profile.

Such holders do not here necessarily need to be fastened to the guide profile. It is sufficient that these are arranged adjacent to the guide profile in order to be able to create the said free space next to the guide profile.

These holders can be realized as separate holders, but could also form part of a larger element for the mounting of the guide profile, which element is then provided with the necessary openings to form the said holders and the said free space.

Separate holders of this type can be easily installed, depending on the marginal conditions. If, for example, the guide profile is placed in front of a door or frame opening with drainage openings, it can thus be ensured that these leave the drainage openings clear, so that runoff from these drainage openings can be led via the free space between these holders.

Where these holders form part of a larger element, the openings which are made in this larger element to form the said holders are made sufficiently large to, as far as possible, take account of deviating configurations of drainage openings, so that runoff from these drainage openings can still be led via the free space between these holders.

Such holders also leave relatively large spaces next to the guide profile vacant, so that dust and dirt, via these spaces, can be kept away from the actual guide of the screen, where this dust and dirt leaves the guidance of the screen unimpeded and can be more easily removed should it begin to accumulate.

The guide profile of a guide device according to an embodiment of this invention can be realized as a lath guide, in which an end lath, which is fastened to the screen on the side of the screen opposite to the side where the screen is rolled up and unrolled, is guidingly fittable for the guidance of this end lath during the roll-up and unrolling movement of the screen.

In addition, the guide profile can be provided, for example, for guiding the bottommost side of the screen with the aid of brushes, such as is known, for example, in the screen device from US 2003/0079844 A1.

Preferably, however, the screen is provided on the said bottommost side with a flexible thickening, and the guide profile is realized as a screen guide, in which this flexible thickening is guidingly fittable for the guidance of this flexible thickening during the roll-up and unrolling movement of the screen. As is known, a flexible thickening of this type can be realized, for example, as a half-zip or a cord, etc.

Preferably, the guide profile is detachably fastenable to the holders. This can be done, for example, by providing the guide profile with one or more slots or ribs and the holders with one or more corresponding ribs or slots, so that the guide profile is detachably fastenable to the holders by hooking of the ribs into the corresponding slots.

Such ribs or slots can assume all kinds of shapes and can also, for example, be realized in a hook shape.

In one specific embodiment, the holders comprise a cavity, which is defined by a base, two sides standing vertical to the base, and two collars, which extend away from the base, with respect to the vertical sides, towards each other, so that a said slot extends between each collar, corresponding side and base, and the screen guide comprises two flanges, forming the said ribs, which in the mounted state each extend at least partially into a corresponding slot in the cavity.

In order to hide the said holders from view, the guide device can advantageously comprise an outer profile in which the holders are fastenable, so that, following fastening of the holders in the outer profile and following mounting of the guide profile on the holders, the guide profile is arranged in the outer profile.

An object of this invention may be additionally achieved by providing a guide assembly, comprising a door or frame profile with one or more drainage openings and an above-described guide device according to an embodiment of this invention without outer profile, for guiding the bottommost side of a screen which can be rolled up and unrolled on an erected screen roller, or a horizontally displaceably erected screen, during the roll-up and unrolling movement or the sliding movement of this screen, wherein the guide profile of this guide device is provided to be mounted against the door or frame profile, and wherein the holders are mounted next to the one or more drainage openings against the door or frame profile, and the guide profile is mounted, away from the door or frame profile, against the holders in order to mount this guide profile against the door or frame profile, so that runoff from the one or more drainage openings can be diverted between the holders.

Such holders do not here necessarily need to be fastened to the door or frame profile or to the guide profile. It is sufficient that these are arranged adjacent to the door or frame profile and adjacent to the guide profile in order to be able to create the said free space next to the guide profile.

Preferably, the holders of such a guide assembly comprise two legs and these holders are realized with a virtually L-shaped cross section, wherein a first leg of each holder is provided to extend in the mounted state substantially between the guide profile and the door or frame profile, and the second leg of each holder is provided to extend in the mounted state substantially below the guide profile, so that runoff from the one or more drainage openings can flow away between the holders via the rear side and the bottom side of the guide profile.

An object of this invention may be further achieved by providing a screen device comprising an erected screen roller, a screen which can be rolled up and unrolled on this screen roller, and an above-described guide device according to embodiments of this invention for guiding the bottommost side of the screen during the roll-up and unrolling movement of this screen.

In addition, an object of this invention may be achieved by providing a screen device comprising a horizontally displaceably erected screen, and an above-described guide device according to an embodiment of this invention for guiding the bottommost side of the screen during the sliding movement of this screen.

An object of this invention may be further achieved by providing an assembly of such a screen device according to an embodiment of this invention and a door or frame profile, which latter, together with the guide device of the screen device, forms part of an above-described guide assembly according to an embodiment of this invention.

Finally, an object of this invention may also be achieved by providing a method for mounting a guide profile of an above-described guide device according to an embodiment of this invention without outer profile, for guiding the bottommost side of a screen which can be rolled up and unrolled on an erected screen roller, or a horizontally displaceably erected screen on a door or frame profile, wherein the holders are mounted against the door or frame profile, next to the one or more drainage openings, and wherein the guide profile is mounted, away from the door or frame profile, against the holders.

### BRIEF DESCRIPTION OF THE DRAWINGS

This invention is now more closely explained with reference to the hereinafter following detailed description of a guide device and method according to this invention. The aim of this description is to provide solely illustrative examples and to indicate further advantages and particularities of this invention, and can thus not be interpreted as a limitation of the field of application of the invention or of the patent rights claimed in the claims.

In this detailed description, reference is made by means of reference numerals to the hereto appended drawings, wherein in

FIG. 1 an embodiment of a screen device according to this invention is depicted in perspective, with holders for the mounting of the topmost lath guide and with a cut-away bottommost lath guide in order to offer a view of the herein accommodated holders for the mounting of the screen guide;

FIG. 2 the bottom side of a frame having a frame profile with drainage openings is depicted in perspective;

FIG. 3 is depicted in perspective how the holders for mounting of the bottommost lath guide of the screen device from FIG. 1 are mounted against the frame profile from FIG. 2;

FIG. 4 is depicted in perspective how the bottommost lath guide of the screen device from FIG. 1 is mounted against the frame profile from FIG. 2;

FIG. 5 the cut-away bottommost lath guide from the screen device from FIG. 1 is represented in more detail in perspective, without screen guide;

FIG. 6 the bottommost lath guide from the screen device from FIG. 1, together with the holders for the mounting of this bottommost lath guide, is depicted from below in perspective, with a view of these holders;

FIG. 7 the bottommost lath guide from the screen device from FIG. 1 is depicted in cross section, together with a holder for the mounting of this lath guide, and the herein fitted screen guides with a holder for the mounting of this screen guide.

### DETAILED DESCRIPTION OF EMBODIMENTS

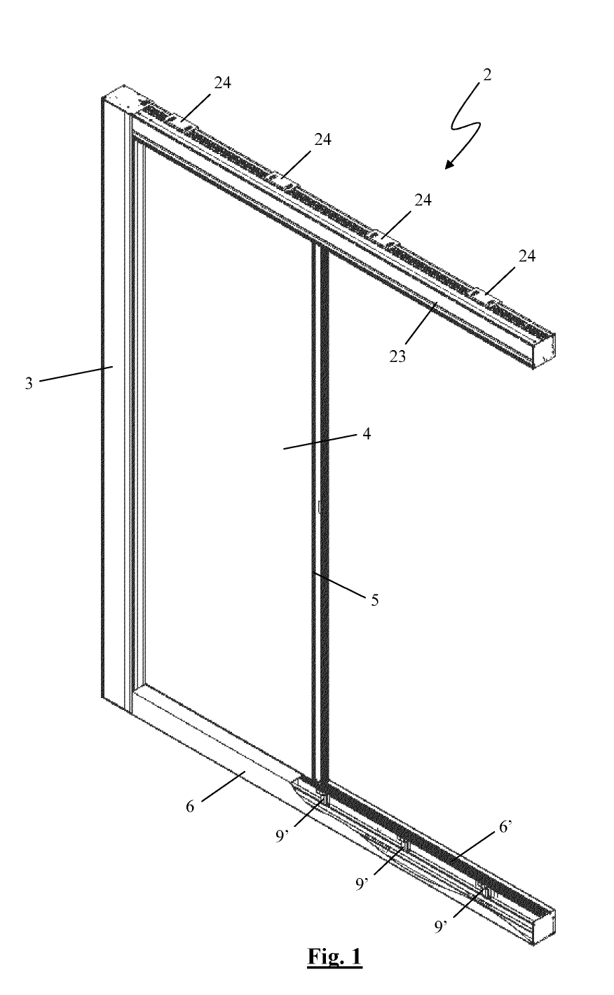

That assembly of a screen device (2) and a frame profile (21) which is depicted in the figures comprises a screen device (2) which is depicted separately in FIG. 1 and a frame profile (21) which is depicted separately in FIG. 2.

The screen device (2) from this assembly is provided to be mounted in front of the frame profile (21) in order thus to be able to at least partially close off or to be able to liberate the frame which is delimited by this frame profile (21). This screen device (2) comprises for this purpose a screen (4), which can be rolled up and unrolled on a vertical screen roller. This screen roller is accommodated in a vertically placed screen box (3).

On the side away from the side where the screen (4) is rolled up and unrolled on the screen roller, an end lath (5) is fastened to the screen (4). The end of this end lath (5) at the bottom of the screen device (2) is guidingly fitted in the bottommost lath guide (6), so that this end, during the roll-up and unrolling movement of the screen (4), is guided in this bottommost lath guide (6). The end of the end lath (5) at the top of the screen device (2) is guidingly fitted in the topmost lath guide (23), so that this end, during the roll-up and unrolling movement of the screen (4), is guided in this topmost lath guide (23).

On both lateral sides, the screen (4) is provided with a half-zip, which is guidingly accommodated in a screen guide (6′), arranged in the respective lath guide (6, 23), for guiding this half-zip and the corresponding lateral side of the screen (4) during the roll-up and unrolling movement of the screen (4).

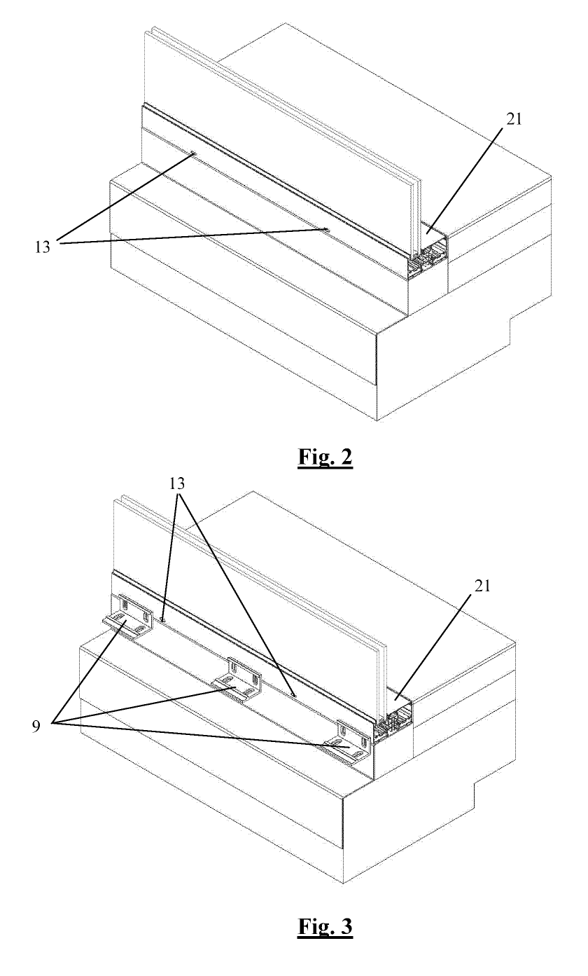

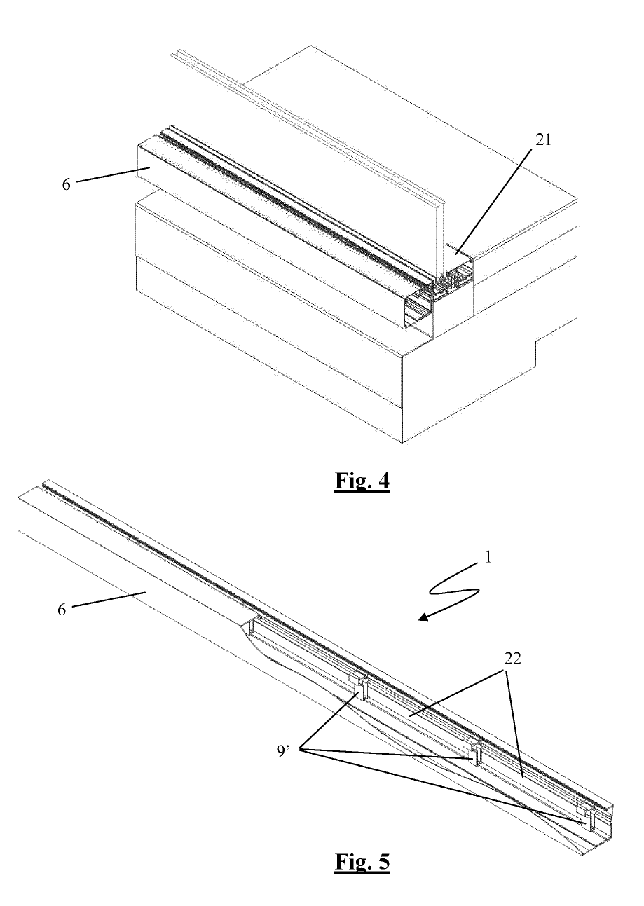

The frame profile (21) is provided with drainage openings, as can be seen in FIGS. 2 and 3.

In order to mount the bottommost lath guide (6) against the frame profile (21), the screen device (2) comprises first holders (9), which are more clearly visible in FIGS. 3, 6 and 7. The topmost lath guide (23) can be mounted with similar holders (24) against a topmost frame profile which delimits the said frame.

The first holders (9) for the mounting of the bottommost lath guide (6) comprise two legs (14, 15) and are realized with a virtually L-shaped cross section.

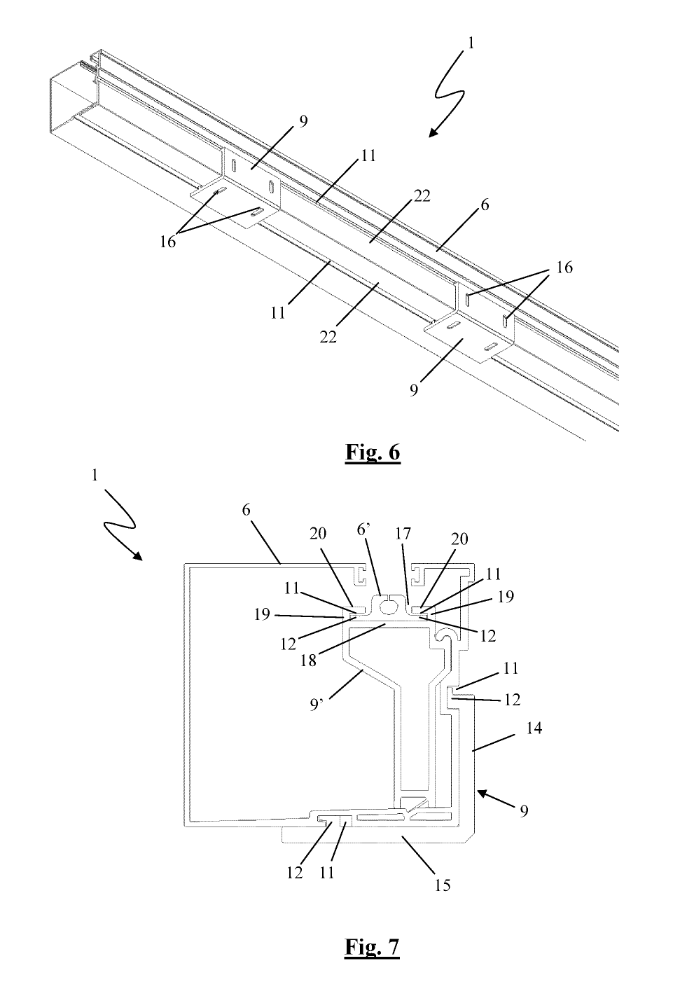

A first leg (14) of each first holder (9) is mounted against the frame profile (21), as can be seen in FIG. 3, and extends, following assembly, on the rear side of the bottommost lath guide (6), as can be seen in FIGS. 6 and 7, so as thus to extend between the guide profile (6) and the frame profile (21). A second leg (15) of each first holder (9) extends, following assembly, at the bottom of the bottommost lath guide (6), as can be seen in FIGS. 6 and 7.

Each leg (14, 15) of the first holders (9) is provided with a hook-shaped rib (12), which can be fitted in a corresponding slot (11) of the bottommost lath guide (6) in order to fasten this bottommost lath guide (6) detachably to these first holders (9).

As can be seen in FIG. 3, the first holders (9) are mounted at a distance apart next to the drainage openings (13) in the frame profile (21). In this way, a free space (22) between these first holders (9), the bottommost lath guide (6) and the frame profile (21), and a free space (22) between these first holders (9) at the bottom of the bottommost lath guide (6), are left clear. Run-off which comes out of the drainage openings (13) in the frame profile (21) can thus be led off via these free spaces (22).

In the first holders (9) are provided openings (16), so that it is possible, depending on the marginal conditions, to fasten these first holders (9) to the environment. Here these first holders (9) could be fastened to the frame profile (21), for example, with the aid of screws. However, these first holders (9) could also be fastened to this frame profile (21), for example, with the aid of bonding. If these first holders (9) could be placed on a base surface, it would also be possible, for example, to fasten these first holders (9) to this base surface with the aid of screws. Alternative fastening methods with alternative fastening means are, of course, conceivable.

These first holders (9) and bottommost lath guide (6) together form a first embodiment of a guide device (1) according to this invention. Together with the frame profile (21), they form a guide assembly (1) according to an embodiment of this invention.

In the bottommost lath guide (6) is accommodated the corresponding screen guide (6′) with the aid of second holders (9′), as can more clearly be seen in FIGS. 5 and 7.

Each of these second holders (9′) comprises a cavity (17), which is defined by a base (18), two sides (19) standing vertical to the base (18), and two collars (20), which extend away from the base (18), with respect to the vertical sides (19), towards each other, so that a slot (11) extends between each collar (20), corresponding vertical side (19) and base (18). The screen guide (6′) comprises two flanges (12), forming the said ribs (12), which in the mounted state each extend at least partially into a corresponding slot (11) in the cavity (17). In this way, the screen guide (6′) is detachably attached to the second holders (9′).

The second holders (9′) are arranged at a distance apart in the bottommost lath guide (6), so that dust and dirt will fall next to the screen guide (6′), this in the bottommost lath guide (6). In this way, this dust or dirt leaves the sliding movement of the screen (4) in this screen guide (6′) unimpeded. The bottommost lath guide (6) can consist, for example, of a plurality of parts, wherein one of these parts is easily detachable, so that the dust and dirt which accumulates in this bottommost lath guide (6) can be easily removed, if necessary, by detachment of one of these parts.

These second holders (9′) and screen guide (6′) together form a second embodiment of a guide device (1) according to this invention.

1. Guide device for guiding the bottommost side of a screen which can be rolled up and unrolled on an erected screen roller, or a horizontally displaceably erected screen, during the roll-up and unrolling movement or the sliding movement of this screen, comprising a guide profile, wherein this guide device comprises a plurality of holders for the guide profile, for the mounting of the guide profile, such that these holders, following assembly, viewed in the longitudinal direction of the guide profile, are arranged at a distance apart, so that a free space extends between these holders and such that each holder extends at least partially alongside and/or at least partially below the guide profile.

2. Guide device according to claim 1, characterized in that the guide profile is realized as a lath guide, in which an end lath, which is fastened to the screen on the side of the screen opposite to the side where the screen is rolled up and unrolled, is guidingly fittable for the guidance of this end lath during the roll-up and unrolling movement of the screen.

3. Guide device according to claim 1, characterized in that the screen is provided on the said bottommost side with a flexible thickening, and in that the guide profile is realized as a screen guide, in which this flexible thickening is guidingly fittable for the guidance of this flexible thickening during the roll-up and unrolling movement of the screen.

4. Guide device according to claim 1, characterized in that the guide profile is detachably fastenable to the holders.

5. Guide device according to claim 4, characterized in that the guide profile comprises one or more slots or ribs, and in that the holders comprise one or more corresponding ribs or slots, so that the guide profile is detachably fastenable to the holders by hooking of the ribs into the corresponding slots.

6. Guide device according to claim 3, wherein the guide profile comprises one or more slots or ribs, and in that the holders comprise one or more corresponding ribs or slots, so that the guide profile is detachably fastenable to the holders by hooking of the ribs into the corresponding slots, wherein the holders comprise a cavity, which is defined by a base, two sides standing vertical to the base, and two collars, which extend away from the base, with respect to the vertical sides, towards each other, so that a said slot extends between each collar (20), corresponding vertical side and base, and in that the screen guide comprises two flanges, forming the said ribs, which in the mounted state each extend at least partially into a corresponding slot in the cavity.

7. Guide device according to claim 1, characterized in that the guide device comprises an outer profile in which the holders are fastenable, so that, following fastening of the holders in the outer profile and following mounting of the guide profile on the holders, the guide profile is arranged in the outer profile.

8. Guide assembly, comprising a door or frame profile with one or more drainage openings and a guide device for guiding the bottommost side of a screen which can be rolled up and unrolled on an erected screen roller, or a horizontally displaceably erected screen, during the roll-up and unrolling movement or the sliding movement of this screen, wherein this guide device comprises a guide profile which is provided to be mounted against the door or frame profile, wherein the guide device is a guide device according to claim 1, and wherein the holders are mounted next to the one or more drainage openings against the door or frame profile, and the guide profile is mounted, away from the door or frame profile, against the holders in order to mount this guide profile against the door or frame profile.

9. Guide assembly according to claim 8, characterized in that the holders comprise two legs and are realized with a virtually L-shaped cross section, wherein a first leg of each holder is provided to extend in the mounted state substantially between the guide profile and the door or frame profile, and the second leg of each holder is provided to extend in the mounted state substantially below the guide profile.

10. Screen device comprising an erected screen roller, a screen which can be rolled up and unrolled on this screen roller, and a guide device for guiding the bottommost side of the screen during the roll-up and unrolling movement of this screen, wherein the guide device is a guide device according to claim 1.

11. Screen device comprising a horizontally displaceably erected screen and a guide device for guiding the bottommost side of the screen during the sliding movement of this screen, wherein the guide device is a guide device according to claim 1.

12. Assembly of a screen device and a door or frame profile, characterized in that the screen device is a screen device according to claim 10, wherein the guide device of the screen device and the door or frame profile form part of a guide assembly, the door or frame profile having one or more drainage openings and the guide device for guiding the bottommost side of the screen which can be rolled up and unrolled on the erected screen roller, during the roll-up and unrolling movement of this screen, wherein the guide device comprises a guide profile which is provided to be mounted against the door or frame profile, wherein the holders are mounted next to the one or more drainage openings against the door or frame profile, and the guide profile is mounted, away from the door or frame profile, against the holders in order to mount this guide profile against the door or frame profile.

13. Method for mounting a guide profile of a guide device for guiding the bottommost side of a screen which can be rolled up and unrolled on an erected screen, or a horizontally displaceably erected screen, on a door or frame profile, wherein as the guide device is taken a guide device according to claim 1, in that the holders are mounted against the door or frame profile, next to the one or more drainage openings, and in that the guide profile is mounted, away from the door or frame profile, against the holders.
